(19) United States
(12) Patent Application Publication
(10) Pub. No.: US 2015/0120375 A1
(43) Pub. Date: Apr. 30, 2015

(54) MANAGING TASKS OF WORKFLOWS STORED AS DATA OBJECTS IN A DATABASE

(71) Applicant: salesforce.com, inc., San Francisco, CA (US)

(72) Inventors: Carl Richard Nelson, San Francisco, CA (US); Thomas Schluchter, San Francisco, CA (US)

(21) Appl. No.: 14/512,707

(22) Filed: Oct. 13, 2014

Related U.S. Application Data
(60) Provisional application No. 61/896,241, filed on Oct. 28, 2013.

(51) Int. Cl. G06Q 10/06

(52) U.S. Cl. CPC G06Q 10/06316
USPC 705/7.26

(57) ABSTRACT

Disclosed are examples of systems, apparatus, methods and computer program products for maintaining workflows to manage tasks assigned to a user of a computing system. For example, first data indicating a user selection to perform a first action can be received via a computing device associated with the user. A first workflow can be identified from a plurality of unique candidate workflows based at least in part on the first action and on metadata associated with the first action. The plurality of unique candidate workflows can be stored as data objects in a database. Each candidate workflow can comprise a set of tasks assigned to the user. Each set of tasks can be related to performance of one or more aspects of business of an organization with which the user is affiliated. One or more tasks of the first workflow can be identified or generated based at least in part on the first action and on the first workflow. Second data indicating the one or more tasks can be provided to the computing device associated with the user. The second data can be processed by a processor of the computing device to display a presentation of the one or more tasks on a display of the computing device.

### PRIORITY DATA

This patent document claims priority to co-pending and commonly assigned U.S. Provisional Patent Application No. 61/896,241, titled “System and Method for Communication Tasks Based on Customer Relationship Management Records”, by Nelson et al., filed on Oct. 28, 2013 (Attorney Docket No. 1334PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to managing tasks in a database system. More specifically, this patent document discloses techniques for maintaining workflows to manage tasks using a database system.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users can interact with cloud computing services to undertake a wide range of tasks.

### BRIEF DESCRIPTION OF THE DRAWINGS

The included drawings are for illustrative purposes and serve only to provide examples of possible structures and operations for the disclosed inventive systems, apparatus, methods and computer program products for managing tasks of workflows stored as data objects in a database. These drawings in no way limit any changes in form and detail that may be made by one skilled in the art without departing from the spirit and scope of the disclosed implementations.

FIG. 1 shows a flowchart of an example of a computer-implemented method 100 for maintaining workflows to manage tasks assigned to a user of a computing system, performed in accordance with some implementations.

FIG. 2 shows an example of a presentation 200 displayed on a mobile device in the form of a graphical user interface (GUI) for maintaining workflows to manage tasks in accordance with some implementations.

FIG. 3 shows an example of a presentation 300 displayed on a mobile device in the form of a GUI for maintaining workflows to manage tasks in accordance with some implementations.

FIG. 4 shows an example of a presentation 400 displayed on a mobile device in the form of a GUI for maintaining workflows to manage tasks in accordance with some implementations.

FIG. 5 shows an example of a presentation 500 displayed on a mobile device in the form of a GUI for maintaining workflows to manage tasks in accordance with some implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for maintaining workflows to manage tasks, such as filling out sales reports or logging phone calls, assigned to a user of a computing system. One non-limiting example of various examples of such a computing system is the Salesforce1® platform, provided by salesforce.com, inc. As discussed herein, a workflow can be structured as one or more data objects stored and maintained in a database system and generally identifies to a set of related tasks. For example, a workflow might be stored in a database as a particular database object identifying an event or activity such as a sale and might identify tasks relating to the sale, such as debiting an account or shipping a product.

Oftentimes an individual juggles an excess of related and unrelated tasks. The disclosed techniques can be used to sort an unfocused jumble of tasks, such as navigating to a sales record, or making a phone call as part of distinct workflows. By way of example, Collins, a used car salesman, uses his computing device to work on his income taxes. Collins then views his Facebook® page before resuming work on his taxes again. Next, he sends an e-mail message to Charlotte, a potential buyer of one of Collins' used cars. He proceeds to take a break and browses a news website, before scheduling an appointment with Charlotte to look at the car she might want to buy. He finally finishes his taxes the following evening. Collins' seemingly aimless navigation pattern can be organized into workflows by identifying workflows corresponding to each action. For instance, the actions Collins has taken towards selling a car to Charlotte, such as scheduling an appointment and sending her an e-mail can be identified as one workflow. Similarly, Collins' actions in completing his taxes might be identified as another workflow. Even Collins' leisure activities, such as viewing his Facebook® page or browsing a news website, could potentially be identified as a workflow.

Further facilitating matters for Collins, historical logs of each of his workflows can be displayed in a presentation on his computing device. A historical log of a given workflow, referred to herein as a stack, might include actions that have already been completed as well as recommendations of further tasks. Displaying a presentation of Collins' stacks allows him to easily find his place in a given workflow. For instance, by viewing a presentation of his stacks on his computing device, Collins can see that he has already made an appointment with Charlotte to show her a car, but he is yet to close the deal. Furthermore, additional tasks can be recommended to Collins. For example, once Collins completes his income taxes, he might be automatically prompted to obtain audit protection. The recommendation process, beyond this particular example, is discussed in further detail below.

Stacks can also be helpful for tying up loose ends at the end of a given day. Returning to the aforementioned example, Collins, who is generally disorganized, can view his stacks at the end of every day. He can then determine that how many workflows he began that day and how many he still needs to complete. When Collins has completed a workflow, such as his income taxes, the stack corresponding to the completed workflow can be automatically deleted allowing Collins to stay focused on the work he needs to finish.

Some of the disclosed techniques can ameliorate problems caused by frequent interruptions that are routine in today's work environment. By way of illustration, Fitzwilliam is a sales representative at the Bennet Corporation, a pianoforte (piano) manufacturer. He is in the middle of working on converting a lead and selling twenty pianos to Georgiana, a potential customer, when he receives a phone call from Elizabeth, Chief Executive Officer (CEO) of Bennet Corporation. The phone conversation lasts for several hours and touches on a broad range of subject matter. Traditionally, at the end of the call, Fitzwilliam might merely be directed back to the screen he was viewing prior to the call, forgetting the details of the conversation and losing his place in his work. On the other hand, when Fitzwilliam disconnects from the phone call with Elizabeth, he can be prompted to create a report of the phone conversation. This reduces the chances that Fitzwilliam will become too busy and wait to create a report of the phone call until he has forgotten some details of the conversation. Additionally, since the phone call lasted for several hours, it could be very difficult for Fitzwilliam to remember exactly what he was working on prior to the phone call and what he still needed to do. Thus, after creating the report of the phone call, he can view a presentation of his stacks in order to remember what he had done for the sale to Georgiana.

Along these lines, a device's communication abilities, such as a smartphone's ability to make and receive phone calls, can be leveraged with the device's access to customer relationship management (CRM) records to seamlessly integrate communication-related tasks with the use of CRM records. Returning to the example described above, assume that Fitzwilliam calls Georgiana and finalize the sale of 20 pianos. Responsive to ending the phone call, Fitzwilliam can be prompted to log the call. When, Fitzwilliam logs the successful sale, a CRM record corresponding to Georgiana's account can be transformed from a potential lead, to a current customer. A reminder to verify that Georgiana's order of twenty pianos is shipped on time can then be created.

The disclosed techniques can also be tied into compensation systems to produce a fair and efficient employee payment scheme. For instance, in the CRM context, workers are often compensated on volume, such as the number of calls logged, rather than quality, such as the number of successfully completed workflows. On the other hand, using the disclosed techniques, a worker could be compensated based on whether she successfully closes out workflows. Under this compensation scheme, a worker might be more likely to focus on closing deals rather than following up on as many leads possible, sacrificing the time spent on each lead.

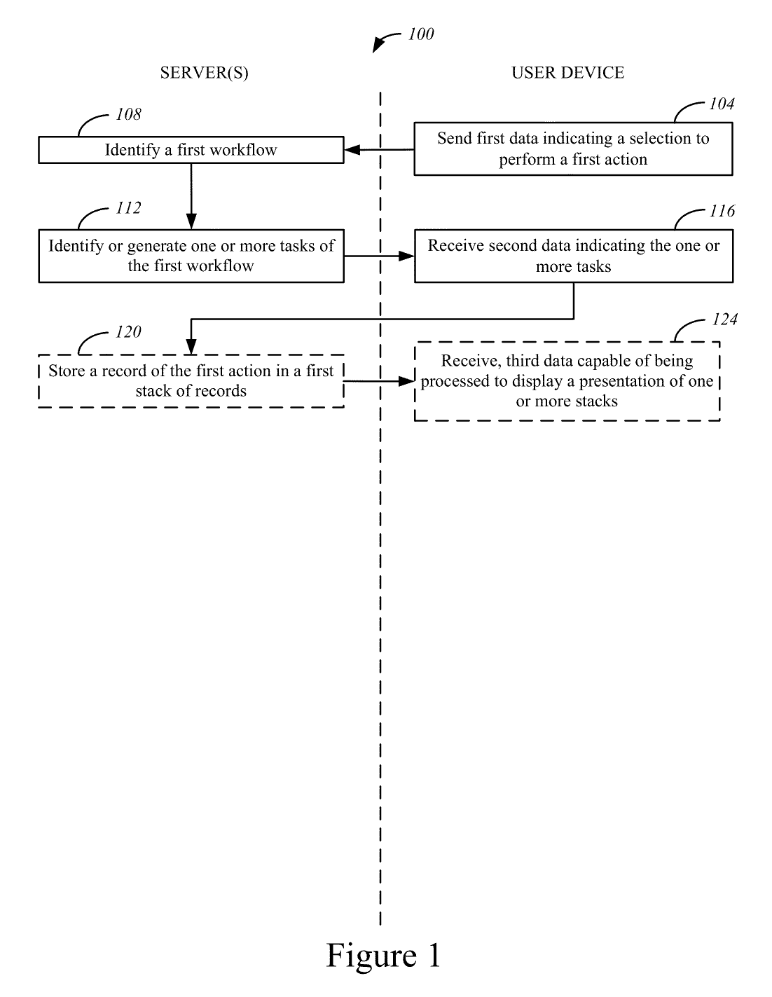

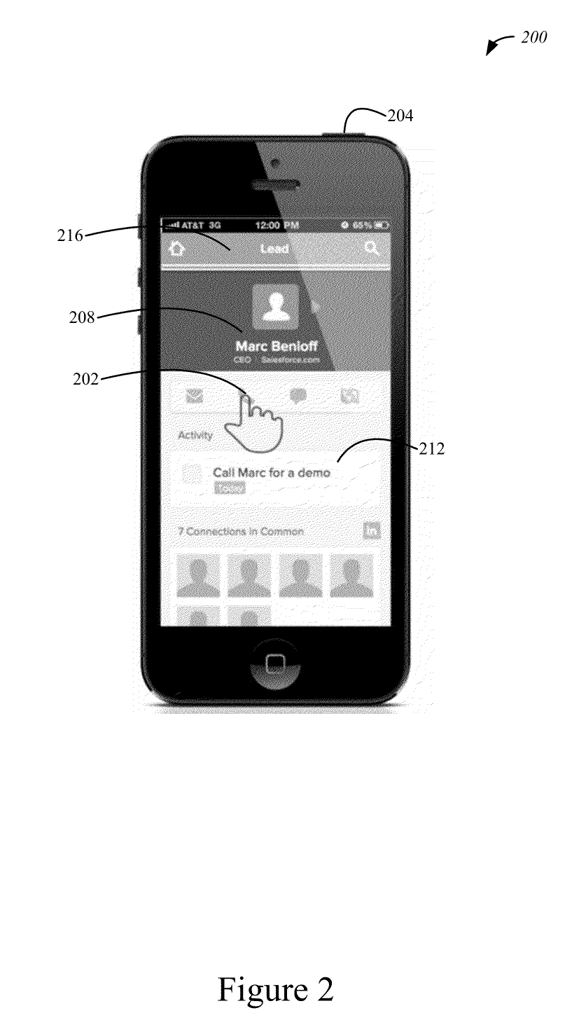

FIG. 1 shows a flowchart of an example of a computer-implemented method 100 for maintaining workflows to manage tasks assigned to a user of a computing system, performed in accordance with some implementations. FIG. 1 is described with reference to FIGS. 2-5. FIGS. 2-5 show examples of presentations displayed on a mobile device in the form of graphical user interfaces (GUIs) for maintaining workflows to manage tasks in accordance with some implementations.

At 104 of FIG. 1, first data indicating a user selection to perform action 202 in the form of a call to Marc Benioff is made on computing device 204 and is received by a server. Device 204 is a smartphone operated by Fitzwilliam, a sales representative at the Bennet Corporation as described above. Icon 208 of FIG. 2 indicates that Fitzwilliam is calling Marc Benioff who is CEO of Salesforce.com® and a potential Bennet Corporation customer. Task reminder 212 reminds Fitzwilliam to call Marc Benioff to schedule a demo of a particular piano manufactured by the Bennet Corporation. While device 204 is a smartphone, one having skill in the art would appreciate that the disclosed techniques can be practiced using a variety of other computing devices, some of which are described below.

At 108 of FIG. 1, workflow 216 is identified. Workflow 216 of FIG. 2 can be identified from a variety of sources. For example, workflow 216 can be identified from a set of unique candidate workflows stored in a database. Such a database might be maintained by Bennet Corporation or by a service provider such as Salesforce.com®. Each candidate workflow in the database could contain a set of tasks assigned to a user such as Fitzwilliam or a group of users such as the sales department at Bennet Corporation. Each set of tasks might relate to performance of business of the Bennet Corporation. For instance, workflow 216 relates to a lead to sell pianos to Marc Benioff.

In some implementations, workflow 216 can be identified based on action 202 and on metadata describing or relating to action 202. More specifically, action 202 surrounds calling Marc Benioff, so metadata describing action 202 might reference a CRM record (or other data object) relating to Marc Benioff, such as his account record or his contact information. Additionally, workflow 216 relates to a lead to sell pianos to Marc Benioff, and, therefore, workflow 216 might also reference a CRM record (or other data object) relating to Marc Benioff, such as his account record or his contact information. Thus, workflow 216 can be identified at 108 because both workflow 216 and the metadata describing action 202 reference the same CRM record.

Metadata describing or relating to an action can include a variety of other information beyond CRM records and data objects. For instance, such metadata might include a timestamp, a geographic location, or a device type. For example, if Fitzwilliam performs action 202 by calling Marc Benioff using his iPhone® from the Pemberley Coffee Shop during his lunch break at 12:00 P.M., metadata describing action 202 might include the timestamp of 12:00 P.M., the geographic location of the Pemberley Coffee Shop, or the iPhone® device type. Metadata could also identify a project, such as an upcoming piano release, a group, such as the sales department at Bennet Corporation, or a navigation action, such as navigating to a social networking feed.

Along these lines, such metadata could even include an identifiable pattern of user behavior. For instance, in the sales field, navigation can be particularly repetitive. By way of example, Fitzwilliam might follow a certain set of steps every time he converts a lead such as making a phone call, logging the phone call immediately thereafter, and announcing the lead conversion on his social networking feed. In this case, metadata describing Fitzwilliam's actions could identify those actions as being part of a sequence that Fitzwilliam follows during a lead conversion because Fitzwilliam completes these actions whenever he converts a lead.

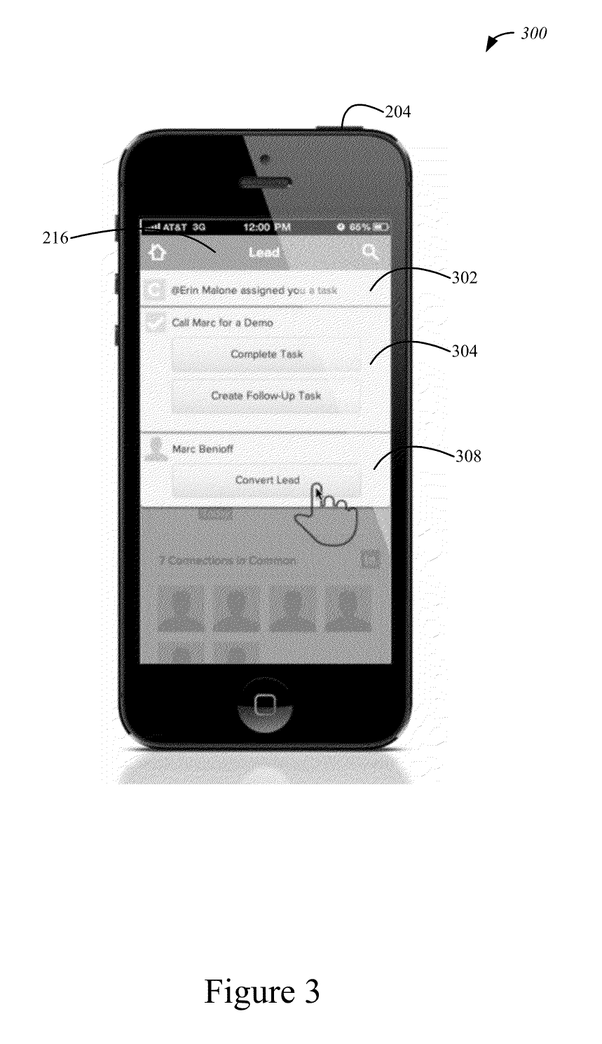

Returning to FIG. 1, at 112, task 308 of FIG. 3 of workflow 216 can be identified based on action 202 and on workflow 216. More specifically, because Fitzwilliam completed task 304, calling Marc Benioff for a demo, by performing action 202, task 308, converting the Marc Benioff lead, which is the next task in workflow 216 can be identified. Task 308 can be identified from a variety of sources. For example, task 302 indicates that Erin Malone has assigned the Marc Benioff lead to Fitzwilliam. In this case, Erin Malone, or another employee of the Bennet Corporation, might have generated tasks 302-308 at the time Fitzwilliam was assigned the Marc Benioff lead. Once tasks 302-308 are generated, they can be stored in a database, as described above, and can be identified from the database at 112.

In some implementations, tasks 302-308 might be assigned to a particular user. For instance, if Fitzwilliam is working alone on the Marc Benioff sale he might be assigned tasks 302-308. On the other hand, tasks 302-308 might be assigned to a group of users. If Marc Benioff is a very important potential customer, Fitzwilliam might be working with sales representatives Bingley and Jane the sale together and are, therefore, all three of them might be assigned tasks 302-308.

Alternatively, at 112 of FIG. 1, task 308 of FIG. 3 of workflow 216 can be generated rather than identified. For example, Marc Benioff might be a completely new customer of the Bennet Corporation. In this scenario, it might not have been clear whether the Marc Benioff lead was worth pursuing and task 308, converting the lead, might not have been generated prior to Fitzwilliam calling Marc Benioff. In this case, task 308 can be generated at 112 responsive to Fitzwilliam calling Marc Benioff.

Also or alternatively, more than one task might be generated or identified at 112. For example, if Marc Benioff decides that he would like to place an order with Bennet Corporation during his phone call with Fitzwilliam, a task to ship the order might also be generated.

Returning to FIG. 1, at 116 second data indicating task 308 is provided to and received by computing device 204. A processor of computing device 204 can process second data to display a presentation 300 of tasks 302-308 on the display of computing device 204.

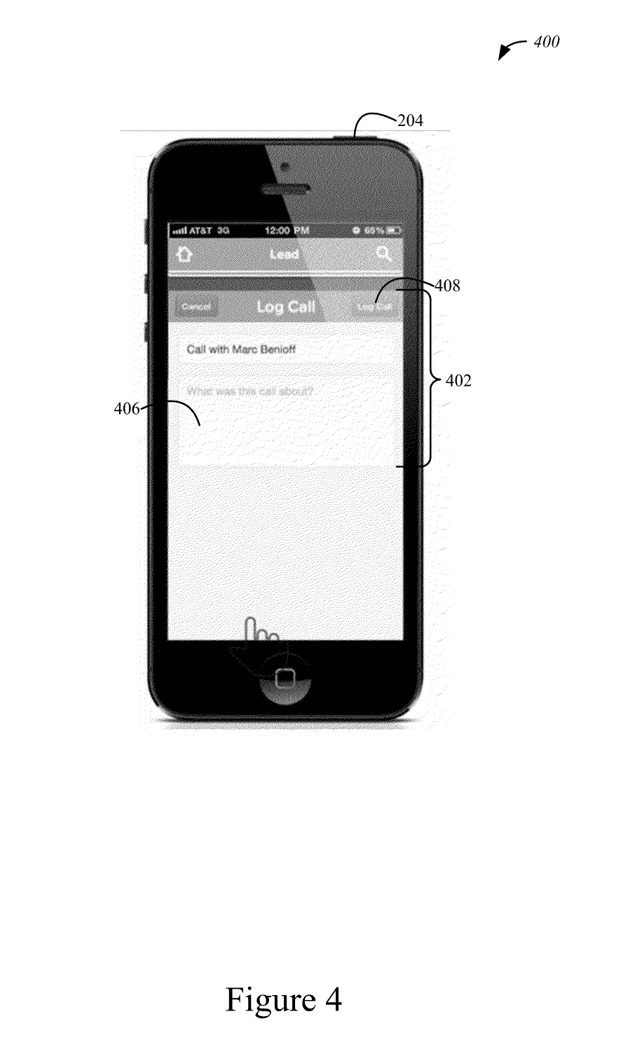

In some implementations, a presentation of tasks on the display of computing device 204 can also include an interface 402 of FIG. 4 for performing tasks. For example, after Fitzwilliam's call to Marc Benioff is completed, interface 402 can be displayed, prompting Fitzwilliam to log the phone call. Fitzwilliam can simply enter the details of his phone conversation with Marc Benioff in textbox 406 while the details are still fresh in his head and click “Log Call” button 408 to complete the task of logging the call.

Also or alternatively, multiple workflows can be identified for a given action. In this scenario, 108-116 can be repeated to identify further workflows and tasks and display a presentation of the further tasks on the display of a device. For example, action 202 of calling Marc Benioff might pertain to more than one workflow because the phone conversation might not only relate to a single sale. By way of example, Fitzwilliam may be calling Marc Benioff not only because Marc Benioff is a potential client of the Bennet Corporation but also because the Bennet Corporation uses the Salesforce.com® platform and Fitzwilliam has been assigned to iron out details relating to a potential contract with Marc Benioff for the Bennet Corporation to use the Salesforce.com® platform. In this example, a workflow relating to the Salesforce.com® contract could also be identified based on action 202.

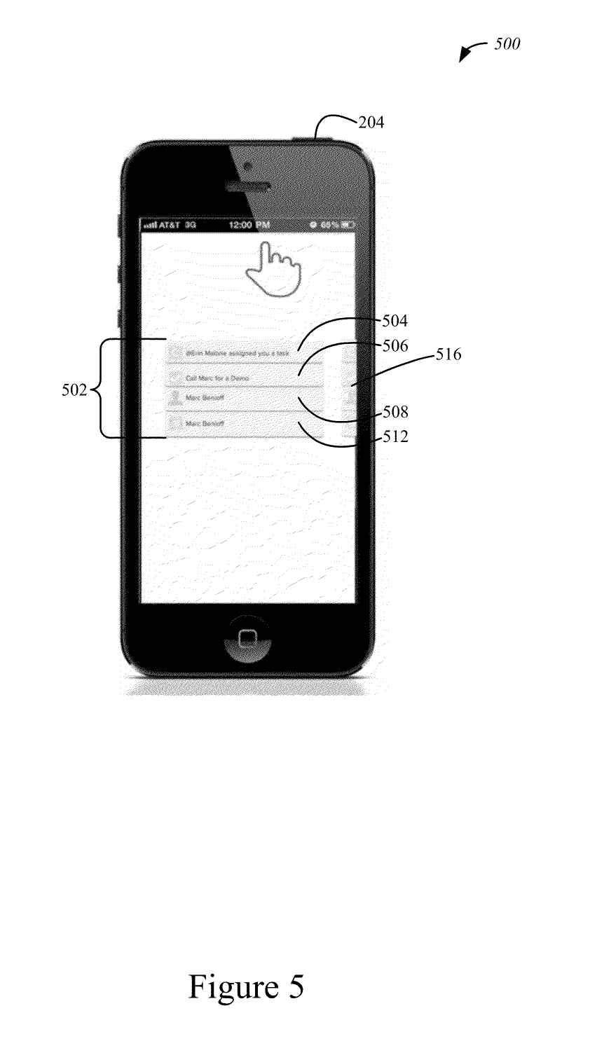

In some implementations, processing of method 100 is completed at 116. In some other implementations, processing continues at 120 where a record 506 of FIG. 5 of action 202 is stored in stack 502, which can be maintained in a database as described above. Stack 502 displays a list of actions that have been taken in workflow 216. Each record 504-512 in stack 502 identifies an action and is unique with respect to other records in stack 502. Additionally, records 504-512 are ordered chronologically.

In some but not all implementations of method 100, at 124 of FIG. 1, third data capable of being processed to display a presentation of stack 502 of FIG. 5 is received by device 204 and provided by a server. In some implementations more than one stack might be displayed. For example, in presentation 500, Fitzwilliam can view other stacks by sliding a finger across the screen of his smartphone or by clicking or tapping menu bar 516. Additionally, each displayed stack can be user-selectable to cause a display of one or more actions stored in a displayed stack.

As described above, some of the disclosed techniques can be used to address an interruption of a workflow such as a phone call. For example, if Fitzwilliam receives a call from Elizabeth while working on the sale to Marc Benioff, it can be determined that an interruption of the workflow 216 has occurred. Responsive to determining that the interruption of workflow 216 has occurred, data indicating some of actions that have been performed by Fitzwilliam relating to workflow 216 can be provided to device 204, e.g. presentation 500 of FIG. 5 can be displayed. Thus, Fitzwilliam can be reminded of his place in workflow 216 after a potentially distracting interruption.

In some implementations, a stack can be removed from being displayed in a presentation after a certain amount of time. For instance, a time measure indicating an amount of time having elapsed since an action was stored in a stack can be determined. If the time measure is greater than or equal to a designated time threshold, the stack can then be removed from being displayed. By way of example, seven months ago Fitzwilliam made a phone call while working on a deal to sell five pianos to Lydia the owner of Wickham Instruments, a musical instrument retailer, which shut down operations two months ago. A stack containing a historical log of actions that have been taken by Fitzwilliam on the deal has been displayed on device 204 since he begun work on the deal. Displaying such a stack might be confusing as well as pointless because Fitzwilliam has not worked on the deal for seven months and will no longer work on the deal because Wickham Instruments has shut down its operations. To fix this problem, Bennet Corporation, or a third party that manages the database containing Bennet Corporation's stacks, can choose to set a designated time threshold of five months after which inactive stacks can be deleted. Thus, the stack corresponding to the Wickham instruments deal can be removed from being displayed on device 204 because seven months, which is greater than the designated five month threshold, has elapsed since an action was stored in the stack.

In some implementations, predicted tasks can be identified or generated, based on a pattern of user behavior. For example, predictive analytics, such as a machine learning algorithm, can be used to recommend tasks to a user based on her previous behaviors. For instance, a random forest model could be applied to predict tasks using past sequences of user behavior as training data, inferring a user's intent from her navigation pattern. Since such predictive analytics can vary greatly across implementations, it can be helpful to look at a simple example. By way of illustration, more than 90% of the time when Fitzwilliam logs into his news feed and sees that an opportunity has elevated to a new stage, he writes a report documenting why the opportunity has been elevated. Thus, if Fitzwilliam logs onto his newsfeed and an opportunity has been elevated, a predicted task of writing a report might be generated. Data can then be provided to device 204 indicating the predicted task of writing a report. The data can be processed by a processor of device 204 to display a presentation the predicted task.

In some implementations, the disclosed techniques can be used to enforce adherence to a sales process. For instance, additional actions that are either required or useful for completing a task or workflow can be identified from a designated set of actions related to a given type of workflow, such as a sale. As described above, such designated sets of actions can be stored in and identified from a database. Data can then be provided to a user device reminding the user of the additional actions. By way of example, there might be ten mandatory steps in the sales process at Bennet Corporation. Fitzwilliam is working on a specific sale and he has completed eight of the ten mandatory steps. Data indicating the two remaining actions can be provided to device 204. The data can be processed by device 204 such that a presentation can be displayed on device 204 prompting Fitzwilliam to complete the two remaining mandatory steps before he closes the sale.

Along these lines, junior employees can be required to follow certain steps whereas for senior employees might just be reminded of these steps. By way of example, Bingley has been a sales representative at Bennet Corporation for only three months whereas Fitzwilliam has been a sales representative at Bennet Corporation for over ten years. Hence, Fitzwilliam might be so experienced with making calls that he is no longer required to formally log every call that he makes. On the other hand, the higher-ups at Bennet Corporation may not yet trust Bingley, so he might be required to log every call that he makes. Thus, actions that are required for Bingley to complete a task or workflow may be optional for Fitzwilliam.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

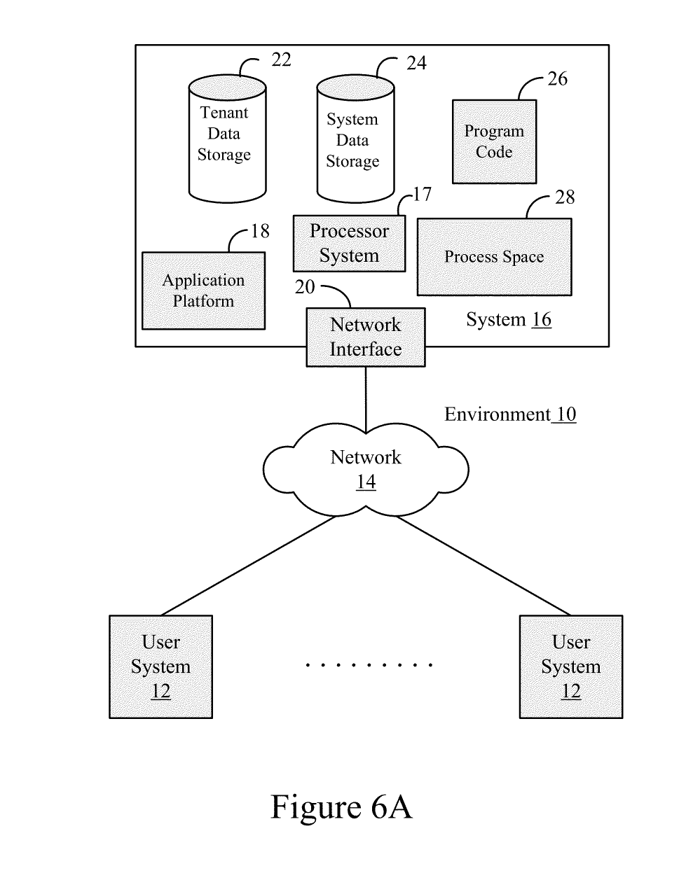

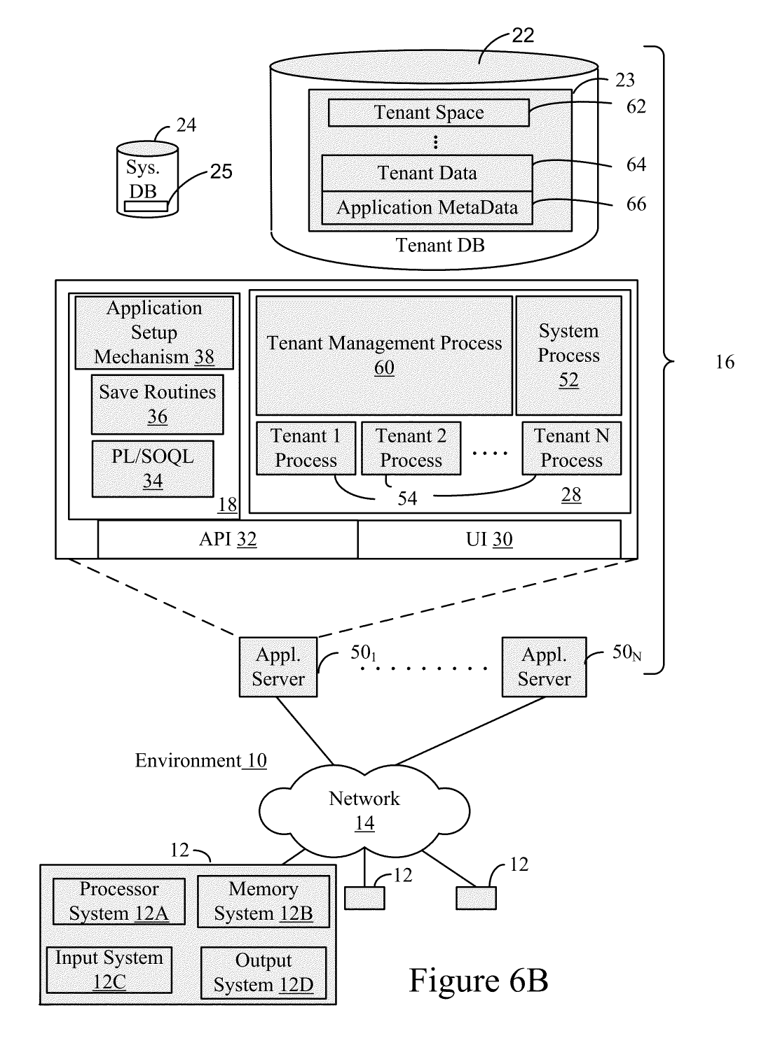

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

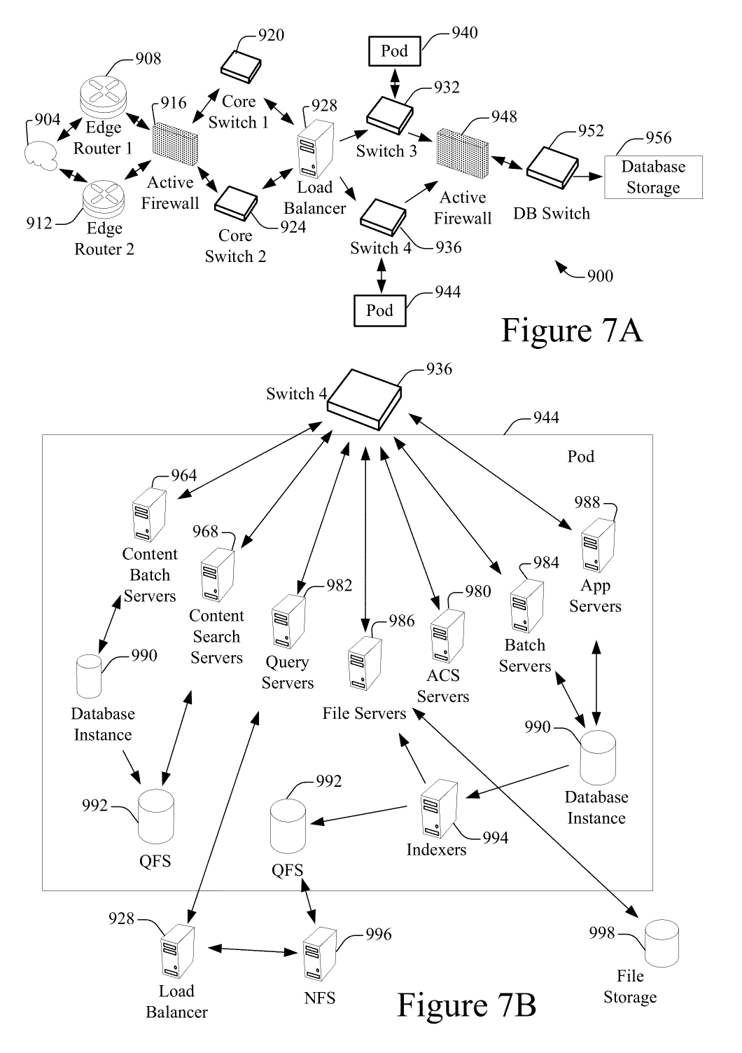

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 7A and 7B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 7A and 7B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to cause performance of services described herein, including performance of one or more of the operations of methods described herein with reference to FIGS. 1-5. In alternative implementations, two or more app servers 988 may be included to cause such methods to be performed, or one or more other servers described herein can be configured to cause part or all of the disclosed methods to be performed.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. Apparatus comprising:
one or more computing devices comprising one or more processors operable to:
receive first data indicating a user selection to perform a first action, the first data received via a computing device associated with the user;
identify, based at least in part on the first action and on metadata associated with the first action, a first workflow from a plurality of unique candidate workflows stored as data objects in a database, each candidate workflow comprising a set of tasks assigned to the user, each set of tasks related to performance of one or more aspects of business of an organization with which the user is affiliated;
identify or generate, based at least in part on the first action and on the first workflow, one or more tasks of the first workflow; and
provide, to the computing device associated with the user, second data indicating the one or more tasks, the second data capable of being processed by a processor of the computing device to display a presentation of the one or more tasks on a display of the computing device.

2. The apparatus of claim 1, the one or more processors being further operable to:
determine that an interruption of the first workflow has occurred; and
provide, responsive to determining that the interruption of the first workflow has occurred, third data indicating at least a portion of actions performed in association with the first workflow.

3. The apparatus of claim 1, wherein the metadata associated with the first action identifies one or more of: a timestamp, a device, a geographic location, a customer relationship management (CRM) object, a project, a group, a navigation action, a data object, or an identifiable pattern of user behavior.

4. The apparatus of claim 1, the one or more processors being further operable to:
store a record of the first action in a first stack of records associated with the first workflow and maintained in the database, each record in the first stack identifying an action and being unique with respect to other records in the first stack, the records in the first stack being ordered chronologically; and
provide, to the computing device associated with the user, third data capable of being processed by a processor of the computing device to display a presentation of one or more stacks including the first stack on the display of the computing device, each displayed stack being user-selectable to cause display of one or more actions stored as records in the displayed stack.

5. The apparatus of claim 4, the one or more processors being further operable to:
determine a first time measure indicating an amount of time having elapsed since an action was stored as a record in the first stack; and
remove, based, in part, on the first time measure being greater than or equal to the designated time threshold, the first stack from being displayed in the presentation.

6. The apparatus of claim 1, wherein the presentation of the one or more tasks on the display of the computing device comprises an interface for performing the one or more tasks.

7. The apparatus of claim 1, the one or more processors being further operable to:
identify, based at least in part on the first action and on the metadata, one or more further workflows from the plurality of unique candidate workflows;
identify or generate, based on the first action and on the one or more further workflows, one or more further tasks to be completed by the user; and
provide, to the computing device associated with the user, third data indicating the one or more further tasks to be completed by the user, the third data capable of being processed by a processor of the computing device to display a presentation of the one or more further tasks on the display of the computing device.

8. The apparatus of claim 1, the one or more processors being further operable to:
identify or generate, based on a pattern of user behavior, one or more predicted tasks to be performed by the user; and
provide, to the computing device associated with the user, third data indicating the one or more predicted tasks to be performed by the user, the third data capable of being processed by a processor of the computing device to display a presentation of the one or more predicted tasks on the display of the computing device.

9. The apparatus of claim 1, the one or more processors being further operable to:
identify, based at least in part on a set of actions associated with a type of workflow, one or more additional actions associated with completing a task or completing a workflow; and
provide, to the computing device associated with the user, third data indicating the one or more additional actions, the third data capable of being processed by a processor of the computing device to display a list of the one or more additional actions.

10. The apparatus of claim 9, wherein the one or more additional actions are required to complete the task or the workflow.

11. The apparatus of claim 1, wherein the computing device is one of: a desktop computer, a laptop computer, a tablet, a smartphone, a television set-top box, and a wearable device.

12. A computer-implemented method for maintaining workflows to manage tasks assigned to a user of a computing system, the method comprising:
receiving first data indicating a user selection to perform a first action, the first data received via a computing device associated with the user;
identifying, based at least in part on the first action and on metadata associated with the first action, a first workflow from a plurality of unique candidate workflows stored as data objects in a database, each candidate workflow comprising a set of tasks assigned to the user, each set of tasks related to performance of one or more aspects of business of an organization with which the user is affiliated;
identifying or generating, based at least in part on the first action and on the first workflow, one or more tasks of the first workflow; and
providing, to the computing device associated with the user, second data indicating the one or more tasks, the second data capable of being processed by a processor of the computing device to display a presentation of the one or more tasks on a display of the computing device.

13. The method of claim 12, further comprising:
determining that an interruption of the first workflow has occurred; and
providing, responsive to determining that the interruption of the first workflow has occurred, third data indicating at least a portion of actions performed in association with the first workflow.

14. The method of claim 12, wherein the metadata associated with the first action identifies one or more of: a timestamp, a device, a geographic location, a customer relationship management (CRM) object, a project, a group, a navigation action, a data object, or an identifiable pattern of user behavior.

15. The method of claim 12, further comprising:
storing a record of the first action in a first stack of records associated with the first workflow and maintained in the database, each record in the first stack identifying an action and being unique with respect to other records in the first stack, the records in the first stack being ordered chronologically; and
providing, to the computing device associated with the user, third data capable of being processed by a processor of the computing device to display a presentation of one or more stacks including the first stack on the display of the computing device, each displayed stack being user-selectable to cause display of one or more actions stored as records in the displayed stack.

16. The method of claim 15, further comprising:
determining a first time measure indicating an amount of time having elapsed since an action was stored as a record in the first stack; and
removing, based, in part, on the first time measure being greater than or equal to the designated time threshold, the first stack from being displayed in the presentation.

17. A computer program product comprising computer-readable program code to be executed by one or more processors when retrieved from a non-transitory computer-readable medium, the program code including instructions configured to cause:
identifying, based at least in part on a first action selected by a user and indicated by first data received via computing device associated with the user and on metadata associated with the first action, a first workflow from a plurality of unique candidate workflows stored as data objects in a database, each candidate workflow comprising a set of tasks assigned to a user, each set of tasks related to performance of one or more aspects of business of an organization with which the user is affiliated;
identifying or generating, based at least in part on the first action and on the first workflow, one or more tasks of the first workflow; and
providing, to the computing device associated with the user, second data indicating the one or more tasks, the second data capable of being processed by a processor of the computing device to display a presentation of the one or more tasks on a display of the computing device.

18. The computer program product of claim 17, the instructions further configured to cause:
determining that an interruption of the first workflow has occurred; and
providing, responsive to determining that the interruption of the first workflow has occurred, third data indicating at least a portion of actions performed in association with the first workflow.

19. The computer program product of claim 17, wherein the metadata associated with the first action identifies one or more of: a timestamp, a device, a geographic location, a customer relationship management (CRM) object, a project, a group, a navigation action, a data object, or an identifiable pattern of user behavior.

20. The computer program product of claim 17, the instructions further configured to cause:
storing a record of the first action in a first stack of records associated with the first workflow and maintained in the database, each record in the first stack identifying an action and being unique with respect to other records in the first stack, the records in the first stack being ordered chronologically; and
providing, to the computing device associated with the user, third data capable of being processed by a processor of the computing device to display a presentation of one or more stacks including the first stack on the display of the computing device, each displayed stack being user-selectable to cause display of one or more actions stored as records in the displayed stack.
